(19) United States
(12) Patent Application Publication
(10) Pub. No.: US 2007/0049236 A1
(43) Pub. Date: Mar. 1, 2007

(54) Frequency conversion apparatus and frequency conversion method for suppressing spurious signals

(75) Inventor: Tomohiro Naito, Gifu (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC., LTD., Moriguchi-shi (JP)

(21) Appl. No.: 11/512,243

(22) Filed: Aug. 30, 2006

(30) Foreign Application Priority Data
Aug. 31, 2005 (JP) 2005-251588

(51) Int. Cl. H04B 1/26

(52) U.S. Cl. 455/323

(57) ABSTRACT

A frequency conversion apparatus includes an SSB mixer and a signal input unit. The signal input unit includes a first input unit and a second input unit. The first input unit inputs a square wave signal to one of the input terminals of the SSB mixer. The second input unit inputs, to the other input terminal of the SSB mixer, a square wave signal that has a clock frequency an even number times that of the square wave signal input from the first input unit. According to these aspects, it is possible to reduce spurious signals with a small-scale circuit configuration.

### BACKGROUND OF THE INVENTION

1. Field of the Invention

The invention relates to a frequency conversion technology, and more particularly to a frequency conversion apparatus and a frequency conversion method for performing frequency conversion on a signal that contains a large number of spurious components.

2. Description of the Related Art

Among the techniques used for converting the carrier frequency of a communication system, one technique includes the use of a mixer. The mixer mixes two signals of different frequencies to generate a signal that has frequency components comprising the sum and the difference of the two frequencies. In the communication system, a predetermined signal is input to one of the inputs of the mixer, and a carrier signal to the other.

In general, a frequency conversion apparatus such as a mixer outputs a mixture of a desired signal and spurious signals due to the nonlinearity of its amplifier devices. These spurious signals can often affect circuits that are located in the subsequent stages of the frequency conversion apparatus, thereby causing malfunction. One of the techniques for avoiding this is a method of eliminating spurious signals by the use of filters (for example, see Japanese Patent Laid-Open Publication No. 2002-374166, FIG. 1). In another method, a single sideband mixer (SSB mixer) is used to reduce the spurious signals (for example, see Japanese Unexamined Patent Laid-Open Publication No. Hei 10-107676, FIG. 1).

Given the above circumstances, the inventor has become aware of the following problem. That is, when using an SSB mixer in a frequency synthesizer or the like, frequency dividers are often connected to the prior stage of the input terminals of the SSB mixer. This produces the problem that spurious-containing signals are output since square waves are input to the input terminals of the SSB mixer.

Square waves typically contain a large amount of harmonic signals, so that the SSB mixer often causes spurious outputs. Moreover, in situations where the SSB mixer outputs a desired wave and spurious waves that have frequencies in proximity to each other, high-order filters having sharp cutoff characteristics or LC resonators having high Q values must be used to filter off the spurious signals as mentioned above. These circuits are extremely large in area, however, and would cause an increase in circuit scale.

### SUMMARY OF THE INVENTION

The present invention has been developed in view of the foregoing circumstances. It is therefore a general purpose of the present invention to provide a frequency conversion apparatus which can reduce spurious signals and avoid malfunction of subsequent circuits without an increase in circuit scale, even when square waves are input to the input terminals of its SSB mixer.

To solve the foregoing problem, a frequency conversion apparatus according to one of the aspects of the present invention includes a first input unit, a second input unit, and a mixer. The first input unit inputs a first signal which includes at least a first sinusoidal signal having a first basic frequency and a first harmonic signal equivalent to a harmonic component three times the first basic frequency. The second input unit inputs a second signal which includes a second sinusoidal signal having a second basic frequency equivalent to a frequency an even number times the first basic frequency and a second harmonic signal equivalent to a harmonic component three times the second basic frequency. The mixer mixes the first signal input from the first input unit with the second signal input from the second input unit. The mixer performs a frequency shift on the first harmonic signal so as to shift to a frequency generated by addition/subtraction between the frequency of the first harmonic signal and the frequency of the second harmonic signal, and performs a frequency shift on the same so as to shift to a frequency generated by addition/subtraction between the frequency of the first harmonic signal and the second basic frequency. The mixer may be a single sideband mixer.

Here, the “addition/subtraction” refers to performing an addition or a subtraction. According to this aspect, the harmonic signal in one of the input signals is mixed with the harmonic signal in the other, having a component an even number times the harmonic component. This makes it possible to shift the harmonic signal included in the one input signal to a frequency equivalent to the value that is generated by addition or subtraction between the frequency of that harmonic signal and the frequency of the harmonic signal included in the other input signal. In other words, the harmonic signal can be shifted to a position away from the basic frequency, i.e., outside the signal band.

Another aspect of the present invention is also a frequency conversion apparatus. This apparatus includes: a first input unit which inputs a first signal which includes at least a first sinusoidal signal having a first basic frequency and a first harmonic signal equivalent to a harmonic component three times the first basic frequency; a second input unit which inputs a second signal which includes at least a second sinusoidal signal having a second basic frequency equivalent to a frequency twice the first basic frequency and a second harmonic signal containing a harmonic component six times the first basic frequency; and a mixer which mixes the first signal input from the first input unit with the second signal input from the second input unit. By mixing the first signal input from the first input unit with the second signal input from the second input unit, the mixer adds the frequency of the first harmonic signal and the second basic frequency to shift the first harmonic signal to a frequency five times the first basic frequency while maintaining at least the first basic frequency of the first sinusoidal signal. The mixer may also add the first basic frequency and the frequency of the second harmonic signal to make a frequency shift to a frequency seven times the first basic frequency. The mixer may also subtract the frequency of the first harmonic signal from the frequency of the second harmonic signal to make a frequency shift to a frequency three times the first basic frequency. The mixer may be a single sideband mixer.

According to this aspect, the sinusoidal signal having the basic frequency in one of the input signals is mixed with the other signal that has a frequency twice the basic frequency. This makes it possible to output the sinusoidal signal having the basic frequency included in the one input signal intactly. The third-order harmonic component included in the one input signal can also be mixed with the twofold basic frequency component or sixfold harmonic component included in the other input signal, so that the signal of the third-order harmonic component included in the first signal is made into a fivefold or sevenfold frequency component. It should be appreciated that addition/subtraction between the harmonic signals is negligible since the resultant has a significantly small amplitude and thus has little impact on the subsequent circuits.

The second input unit may include: a frequency multiplication unit which multiplies the frequency of the first signal input from the first input unit by a predetermined multiplication factor, thereby generating a signal having a frequency an even number times the frequency of the first signal; and a multiplication factor control unit which controls the multiplication factor of the frequency multiplication unit. The first input unit may include: a frequency division unit which divides the frequency of the second signal input from the second input unit by a predetermined division factor, thereby generating the first signal such that the second signal has a frequency an even number times that of the first signal generated; and a division factor control unit which controls the division factor of the frequency division unit.

According to these aspects, the multiplication factor control unit and the division factor control unit can control the frequency multiplication unit and the frequency division unit, respectively, so that the frequencies of the respective signals for the first and second input units to input to the mixer are set flexibly.

The first input unit may include: a plurality of frequency division units which divide the frequency of the second signal input from the second input unit by respective different division factors, thereby generating a respective plurality of signals; a division factor control unit which controls the division factors of the respective plurality of frequency division units so that the second signal has a frequency an even number times each of the plurality of signals generated by the respective plurality of frequency division units; and a selection unit which selects any one of the signals generated by the respective plurality of frequency division units, and inputs the signal to one of the input terminals of the mixer.

According to this aspect, the provision of the plurality of frequency division units can increase alternatives of the signal frequency for the first input unit to input to the mixer.

Yet another aspect of the present invention is also a frequency conversion apparatus. This apparatus includes an input unit, a first frequency division unit, a second frequency division unit, a third frequency division unit, a first mixer, a second mixer, a selection unit, and a third mixer. The input unit inputs a first signal having a first frequency. The first frequency division unit divides the frequency of the first signal input from the input unit by four, thereby generating a signal having a frequency ¼ that of the first signal. The second frequency division unit divides the frequency of the signal divided by the first frequency division unit by two, thereby generating a signal having a frequency ⅛ that of the first signal. The third frequency division unit divides the frequency of the signal divided by the second frequency division unit by two, thereby generating a signal having a frequency 1/16 that of the first signal. The first mixer mixes the signal frequency-divided by the first frequency division unit, having the frequency ¼ that of the first signal, with the signal frequency-divided by the third frequency division unit, having the frequency 1/16 that of the first signal. The second mixer mixes the signal frequency-divided by the second frequency division unit, having the frequency ⅛ that of the first signal, with the signal frequency-divided by the third frequency division unit, having the frequency 1/16 that of the first signal. The selection unit selects any one signal as a second signal from among the signal mixed by the first mixer, the signal mixed by the second mixer, and the signal generated by the third frequency division unit. The third mixer mixes the first signal input from the input unit with the second signal selected by the selection unit. Each of the mixers may be a single sideband mixer.

According to this aspect, the harmonic signal included in one of the input signals of the first and second mixers is mixed with the harmonic signal in the other, having a frequency component an even number times the frequency of the harmonic signal. This makes it possible to shift the frequency of the harmonic component signal included in the first signal to a position away from the basic frequency, i.e., outside the signal band. Moreover, the sinusoidal signal having the basic frequency included in the one input signal of the first or second mixer is mixed with the other signal which has a frequency twice the basic frequency. This makes it possible to output the sinusoidal signal having the basic frequency of the input signal intactly.

Yet another aspect of the present invention is a frequency conversion method. This method includes: inputting a first signal which includes at least a first sinusoidal signal having a first basic frequency and a first harmonic signal having a harmonic component three times the first basic frequency; inputting a second signal which includes a second sinusoidal signal having a second basic frequency equivalent to a frequency an even number times the first basic frequency and a second harmonic signal equivalent to a harmonic component three times the second basic frequency; and mixing the first signal with the second signal. The mixing includes: performing a frequency shift on the first harmonic signal so as to shift to a frequency generated by addition or subtraction between the frequency of the first harmonic signal and the frequency of the second harmonic signal, and outputting the resultant; and performing a frequency shift on the same so as to shift to a frequency generated by addition or subtraction between the frequency of the first harmonic signal and the second basic frequency, and outputting the resultant. When mixing, either one of two frequency components included in the output signal may be eliminated before output. That is, the mixing may include making a single sideband output.

According to this aspect, the harmonic signal included in one of the input signals to be mixed is mixed with the harmonic signal in the other, having a frequency component an even number times the frequency of the harmonic signal. This makes it possible to shift the frequency of the harmonic component signal included in the one signal to outside the signal band. Moreover, the sinusoidal signal having the basic frequency included in the one signal to be mixed is mixed with the other signal which has a frequency twice the basic frequency. This makes it possible to output the sinusoidal signal having the basic frequency of the one input signal intactly.

Another aspect of the present invention is also a frequency conversion method. This method includes inputting a first signal, inputting a second signal, and mixing these signals. In the inputting of a first signal, a first signal including at least a first sinusoidal signal having a first basic frequency is input. In the inputting of a second signal, a second signal including at least a second sinusoidal signal having a second basic frequency equivalent to a frequency twice the first basic frequency is input. In the mixing, the input first and second signals are mixed to output at least a signal that is equivalent to the first sinusoidal signal having the first basic frequency. The mixing may include making a single sideband output.

In the inputting of the first signal, a first harmonic signal including at least a harmonic component three times the first basic frequency may be input further. In the inputting of the second signal, a second harmonic signal including at least a harmonic component six times the first basic frequency may be input further. In the mixing, the frequency of the first harmonic signal and the second basic frequency may be added to perform a frequency shift on the first harmonic signal so as to shift to a frequency five times the first basic frequency before output. The mixing may include making a single sideband output.

The inputting of the second signal may include: multiplying the frequency of the first signal by a predetermined multiplication factor, thereby generating a signal having a frequency an even number times the frequency; and controlling the multiplication factor. The inputting of the first signal may include: dividing the frequency of the second signal by a predetermined division factor, thereby generating the first signal such that the second signal has a frequency an even number times that of the first signal generated; and controlling the division factor.

The inputting of the first signal may include: dividing the frequency of the second signal by respective different division factors, thereby generating a respective plurality of signals; controlling the division factors so that the second signal has a frequency an even number times each of the respective plurality of signals generated; and selecting any one of the generated signals.

Yet another aspect of the present invention is also a frequency conversion method. This method includes an input step, a first frequency division step, a second frequency division step, a third frequency division step, a first mixing step, a second mixing step, a selection step, and a third mixing step. In the input step, a first signal having a first frequency is input. In the first frequency division step, the frequency of the first signal input in the input step is divided by four to generate a signal having a frequency ¼ that of the first signal. In the second frequency division step, the frequency of the signal divided in the first frequency division step is divided by two to generate a signal having a frequency ⅛ that of the first signal. In the third frequency division step, the frequency of the signal divided in the second frequency division step is divided by two to generate a signal having a frequency 1/16 that of the first signal. In the first mixing step, the signal frequency-divided in the first frequency division step, having the frequency ¼ that of the first signal, and the signal frequency-divided in the third frequency division step, having the frequency 1/16 that of the first signal, are mixed. In the second mixing step, the signal frequency-divided in the second frequency division step, having the frequency ⅛ that of the first signal, and the signal frequency-divided in the third frequency division step, having the frequency 1/16 that of the first signal, are mixed. In the selection step, any one signal is selected as a second signal from among the signal mixed in the first mixing step, the signal mixed in the second mixing step, and the signal generated in the third frequency division step. In the third mixing step, the first signal input in the input step and the second signal selected in the selection step are mixed. In each of the mixing steps, either one of two frequency components included in the output signal may be eliminated before output. That is, the mixing steps may include making a single sideband output.

Note that, any combinations of the foregoing components, and any expressions of the present invention transformed from/into methods, apparatuses, and the like are also intended to constitute applicable aspects of the present invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a diagram showing a first example of signals input to an SSB mixer according to the embodiment of the present invention;

FIG. 2 is a diagram showing a second example of the signals input to the SSB mixer according to the embodiment of the present invention;

FIG. 3 is a diagram showing the relationship between the input and output signals of the SSB mixer in FIG. 2;

FIG. 4 is a diagram showing the frequency distributions of the input and output signals of the SSB mixer in FIG. 3;

FIG. 5 is a diagram showing an example of configuration of a frequency conversion apparatus according to the embodiment of the present invention;

FIG. 6 is a diagram showing an example of configuration of the signal input unit according to a modification of the embodiment of the present invention;

FIG. 7 is a diagram showing an example of configuration of the first input unit according to another modification of the embodiment of the present invention;

FIG. 8 is a diagram showing an example of configuration of the frequency conversion apparatus according to yet another modification of the embodiment of the present invention; and

FIGS. 9A to 9C are charts for showing examples of distribution of the frequency components included in respective output signals of the frequency conversion apparatus in FIG. 8.

### DETAILED DESCRIPTION OF THE INVENTION

The invention will now be described by reference to the preferred embodiments. This does not intend to limit the scope of the present invention, but to exemplify the invention.

Before explaining the preferred embodiment of the present invention in concrete terms, description will first be given of an overview of the embodiment of the present invention and the principle of the present invention. The preferred embodiment of the present invention relates to a frequency conversion apparatus which includes an SSB mixer and an input unit which inputs two square waves to the SSB mixer. In the frequency conversion apparatus according to the preferred embodiment of the present invention, the two square wave signals input to the SSB mixer are such that either one has a frequency an even number times that of the other. Harmonic components included in the square waves, i.e., spurious signals, are thereby shifted to outside the signal band.

Description will now be given of the principle. In general, a mixer included in a typical frequency conversion apparatus mixes the frequencies f₁ with f₂ of two input signals to generate a frequency f₁+f₂ and a frequency f₁−f₂. Either one of the signals generated is filtered off or otherwise removed as being an image signal in a subsequent stage of the mixer. On the other hand, the SSB mixer has the function of mixing two pairs of signals, each including orthogonal signals having a phase difference of 90°, so that the image signal is cancelled by itself.

Take the case of generating a signal having a frequency f₁−f₂ from two signals having frequencies f₁ and f₂. If the signals input to the SSB mixer are sinusoidal, it is possible to eliminate the image signal having a frequency f₁+f₂ by the foregoing function of the SSB mixer, and generate the signal having a frequency f₁−f₂ alone. Nevertheless, in such cases that the SSB mixer is used in a frequency synthesizer or the like, frequency dividers are often connected to the prior stages of the input terminals of the SSB mixer. In this instance, the signals input to the SSB mixer are square waves, not sinusoidal waves.

By Fourier series expansion, a square wave having a clock frequency f₀ can be expressed as composite sinusoidal signals having respective frequencies of f₀, 3f₀, 5f₀, . . . , (2k−1)f₀ (k is an integer not smaller than 1), as given by the following equation (1):
sin(2πf₀t)−(⅓)sin(3×2πf₀t)+(⅕)sin(5×2πf₀t)−( 1/7)sin(7×
2πf₀t). Eq. (1)

Consequently, when two square waves are mixed each other in the SSB mixer, their harmonic components are also mixed each other to produce a large number of spurious signals. In this instance, the harmonic components shall include sinusoidal signals having frequencies of (2k−1)f₀, where k is an integer not smaller than 2. The frequency for k=1, i.e., f₀ shall be referred to as the basic frequency. Moreover, the spurious signals refer to harmonic components output from the SSB mixer, including the image signal.

These spurious signals can be eliminated with a band pass filter that is connected to the subsequent stage of the SSB mixer. If the spurious signals lie in the vicinity of the desired wave, however, it becomes necessary to provide circuits of large circuit areas such as a high-order bandpass filter and an LC resonator having high frequency selectivity. This can increase the cost of the semiconductor chip.

The preferred embodiment of the present invention has a configuration capable of reducing spurious signals without using a filter even if square wave signals are input to the SSB mixer, as mentioned above. As will be detailed later, it is possible to reduce spurious signals without the use of a filter by inputting the signal having the clock frequency f₀ to one of the input terminals of the SSB mixer while inputting a signal having a frequency 2f₀ to the other input terminal. Square waves typically contain harmonic signals having frequencies an odd number times the basic frequency as shown by equation (1).

Among the harmonic signals, the third-order component has the maximum amplitude. The amplitude decreases with the increasing order 3, 5, . . . , (2k−1). In fact, the harmonic signals of the fifth and subsequent odd orders have only a small impact because they have small amplitudes as well as large frequency deviations from the basic frequency. For this reason, the following description will deal with harmonic signals of third order alone.

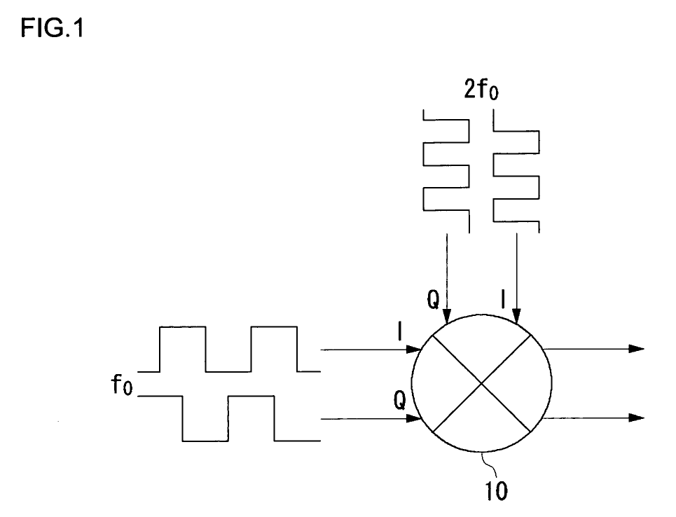

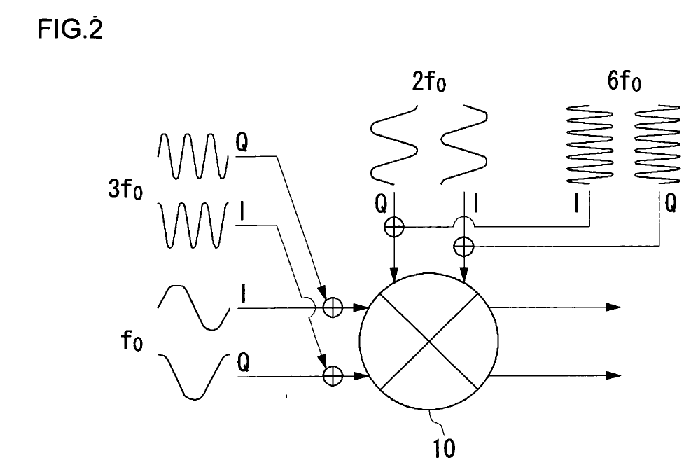

FIG. 1 is a diagram showing a first example of signals input to an SSB mixer 10 according to the preferred embodiment of the present invention. Both a square wave signal having a clock frequency f₀ at one of its input terminals, and a square wave signal having a clock frequency 2f₀ at the other input terminal are input to the SSB mixer 10. That is, one of the input signals has a frequency twice that of the other input signal. In terms of a basic frequency and a third-order harmonic signal, the square wave signals shown in FIG. 1 are expressed as shown in FIG. 2. FIG. 2 is a diagram showing a second example of the signals input to the SSB mixer 10 according to the preferred embodiment of the present invention. In FIG. 2, the sinusoidal signals having respective basic frequencies and their third-order harmonic signals are added as I signals and Q signals in different ways for the reason that the signals have different signs as shown in equation (1). Another reason is that the third-order harmonics make phase changes three times those of the signals having the basic frequencies.

The signals output from the SSB mixer 10 shown in FIG. 2 include four frequency components (2f₀−f₀), (6f₀+f₀), (2f₀+3f₀), and (6f₀−3f₀). In short, f₀, 7f₀, 5f₀, and 3f₀ are included. It should be appreciated that whether to add or subtract the frequency components of the two input signals to generate the frequency components included in the output signal depends on the phase relationship between the input signals, i.e., the relationship between the I and Q signals.

The subtraction between the third-order harmonics is negligible since it involves multiplying the sinusoidal signals of small amplitudes by each other. In other words, the subtraction of the frequency components 6f₀−3f₀ involves multiplying the sinusoidal signals having amplitudes of ⅓. The amplitude after the multiplication is 1/9, which is small when compared to the amplitudes of the other sinusoidal signals. In summary, the foregoing relationship is expressed as the following equation (2):
2f₀(6f₀)*f₀(3f₀)=f₀(5f₀,7f₀). Eq. (2).

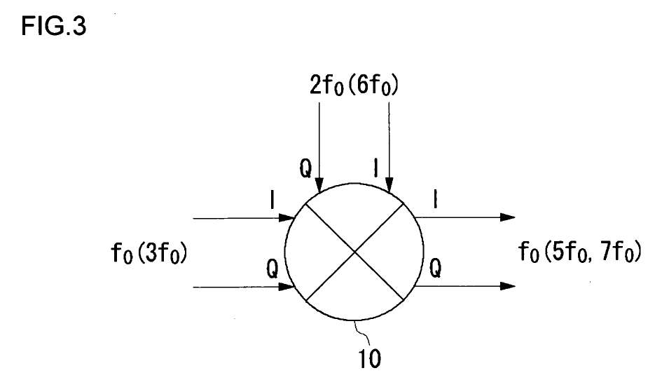

Note that the sign “*” employed in equation (2) shall represent mixing processing in the mixer, not an ordinary multiplication. In addition, X in X(Y) shall indicate the basic frequency, and Y the frequency of the harmonic or spurious signal. The same holds in the following description. Now, based on equation (2), FIG. 2 can be transformed into FIG. 3. FIG. 3 is a diagram showing the relationship between the input and output signals of the SSB mixer 10 in FIG. 2. The frequencies appearing in the parentheses of the input signals in FIG. 3 indicate the harmonic components included in the respective input signals.

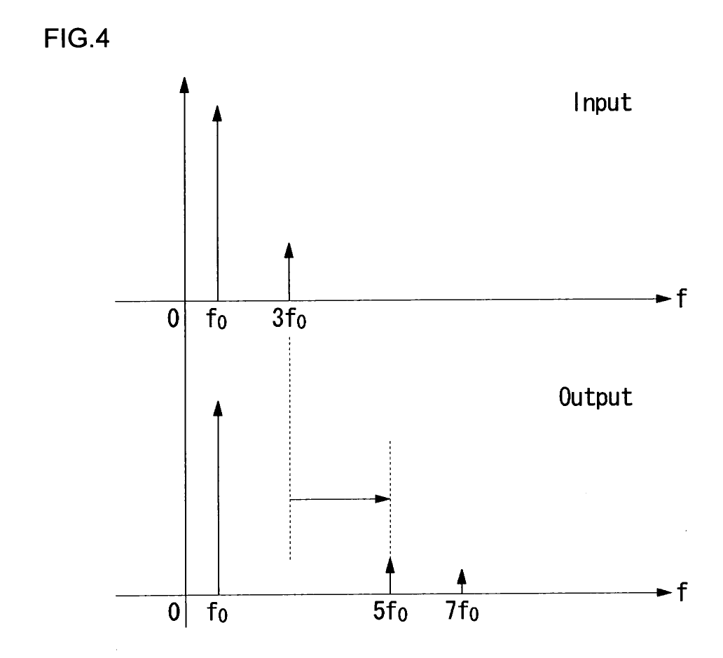

The above discussion leads to the following principle. When a harmonic-containing input signal having a clock frequency f₀ is input to one of the input terminals of the SSB mixer and a signal having twice the frequency is input to the other terminal of the SSB mixer for mutual mix, an output spurious signal occurring from the harmonic component 3f₀ included in the input signal can be shifted to 5f₀ and 7f₀. That is, the harmonic component 3f₀ prior to multiplication can be regarded as being shifted to 5f₀ and 7f₀ after the multiplication. The component of the basic frequency f₀ can be included into the output signal intactly. This relationship is shown in FIG. 4. FIG. 4 is a diagram showing the frequency distributions of the input and output signals of the SSB mixer 10 in FIG. 3. The distribution shown to the top in FIG. 4 is that of the frequency components included in the input signal of the SSB mixer 10. The distribution shown to the bottom is that of the frequency components included in the output signal of the SSB mixer 10. In either case, the horizontal axis indicates the frequency and the vertical axis indicates the amplitude.

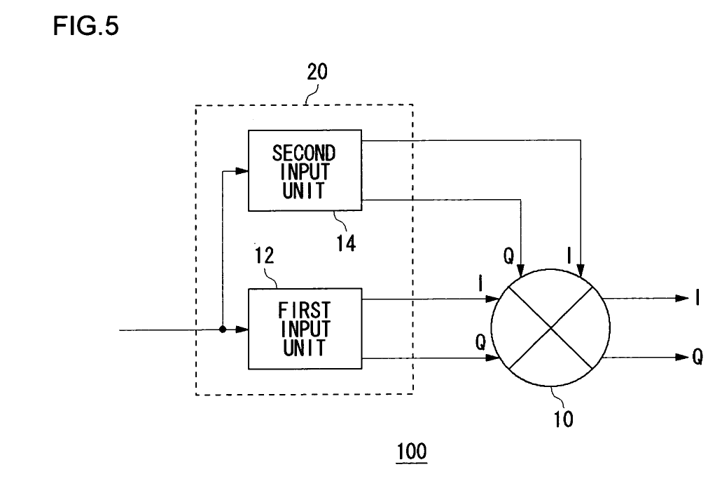

Hereinafter, the configuration of the preferred embodiment of the present invention will be described with reference to the drawings. FIG. 5 is a diagram showing an example of a configuration of a frequency conversion apparatus 100 according to the preferred embodiment of the present invention. The frequency conversion apparatus 100 includes the SSB mixer 10 and a signal input unit 20 which is shown by the broken line in FIG. 5. The signal input unit 20 includes a first input unit 12 and a second input unit 14.

The first input unit 12 inputs a square wave signal to one of the input terminals of the SSB mixer 10. It should be appreciated that the square wave signal may include signals that are not perfectly square in waveform. In other words, the square wave signal also covers signals that do not contain harmonic components of higher order, such as fifth order and more, out of those obtained when a square wave signal is expanded into a Fourier series as described above. That is, the first input unit 12 substantially functions to input a first signal which includes a first sinusoidal signal f₀ having a first basic frequency and at least a first harmonic signal having a harmonic component 3f₀ three times the first basic frequency.

The second input unit 14 inputs, to the other input terminal of the SSB mixer 10, a square wave signal that has a clock frequency an even number times that of the square wave signal input from the first input unit 12. More specifically, the second input unit 14 inputs a second signal that includes a second sinusoidal signal and a second harmonic signal. The second sinusoidal signal has a second basic frequency 2Nf₀ (N is an integer no smaller than 1), i.e., a frequency an even number times the first basic frequency f₀. The second harmonic signal has a harmonic component 6Nf₀ an even number times the harmonic component 3f₀ which is equivalent to three times the first basic frequency f₀.

Alternatively, the second input unit 14 may input a second signal that includes at least the following: a second sinusoidal signal having a second basic frequency 2f₀, i.e., a frequency twice the first basic frequency f₀; and a second harmonic signal having a harmonic component 6f₀ six times the first basic frequency f₀.

It should be noted that any signals may be input to the first and second input units 12 and 14. For example, if the frequency conversion apparatus 100 according to the preferred embodiment of the present invention is mounted on a communication apparatus, the signal to be input to the first input unit 12 is a transmission signal. In other cases, the signal from the second input unit 14, multiplied or divided in frequency, may be input to the first input unit 12. The signal from the first input unit 12, multiplied or divided in frequency, may also be input to the second input unit 14.

The SSB mixer 10 mixes the first signal input from the first input unit 12 and the second signal input from the second input unit 14. Specifically, the SSB mixer 10 performs a frequency shift on the harmonic signal that has at least the harmonic component 3f₀, being three times the first basic frequency f₀, out of the harmonic components included in the first harmonic signal, and outputs the resultant signal. As described above, the frequency shift is intended for a frequency (1+6N)f₀ which is generated by adding the first basic frequency f₀ and the frequency 6Nf₀ of an even number times the threefold frequency 3f₀. The SSB mixer 10 also makes a frequency shift to a frequency (3 +2N)f₀ by adding the frequency 3f₀, being three times the first basic frequency f₀ and the second basic frequency 2Nf₀, and outputs the resultant signal.

Now, description will be given of the case where N=1, i.e., the square wave signal input from the second input unit 14 has a clock frequency twice that of the square wave signal input from the first input unit 12. Here, as described previously, the SSB mixer 10 mixes the first signal input from the first input unit 12 with the second signal input from the second input unit 14. As a result, the SSB mixer 10 can output the intact first sinusoidal signal which has at least the first basic frequency as shown by equation (2).

The SSB mixer 10 also performs a frequency shift on the harmonic signal that contains at least the harmonic component 3f₀, or three times the first basic frequency f₀, and outputs the resultant signal. The frequency shift includes subtracting the frequency 3f₀, or three times the first basic frequency f₀, from the frequency 6f₀, or six times the first basic frequency, thereby obtaining a frequency 3f₀ which is three times the first basic frequency. This component is negligible, however, because of the small amplitude. The SSB mixer 10 also makes a frequency shift to a frequency 5f₀, or five times the first basic frequency, by adding the frequency 3f₀, or three times the first basic frequency f₀ and the second basic frequency 2f₀, and outputs the resultant signal.

According to the foregoing aspect, the harmonic signal in one of the input signals is mixed with the harmonic signal in the other, having a component an even number times the harmonic component. This can shift the frequency of the harmonic signal included in the one input signal to a position away from the basic frequency, i.e., outside the signal band. Moreover, the sinusoidal signal, having the basic frequency of the one input signal, is mixed with the other signal which has a frequency twice the basic frequency. This makes it possible to output the sinusoidal signal having the basic frequency of the one input signal intactly. In addition to this, the third-order harmonic component included in the one input signal is mixed with the second-order basic frequency component or sixth-order harmonic component included in the other input signal. This can make the signal of the third-order harmonic component included in the first signal into a fifth- or seventh-order frequency component.

A modification of the preferred embodiment of the present invention will now be described. This modification of the preferred embodiment of the present invention relates to a frequency conversion apparatus. The frequency conversion apparatus according to this modification has a configuration similar to that of the frequency conversion apparatus 100 shown in FIG. 5. A difference from the preferred embodiment of the present invention consists in the configuration of the signal input unit 20 shown in FIG. 5. It should be appreciated that elements common to the foregoing embodiment will be designated with identical reference numerals, and a description thereof will be given in a simplified form.

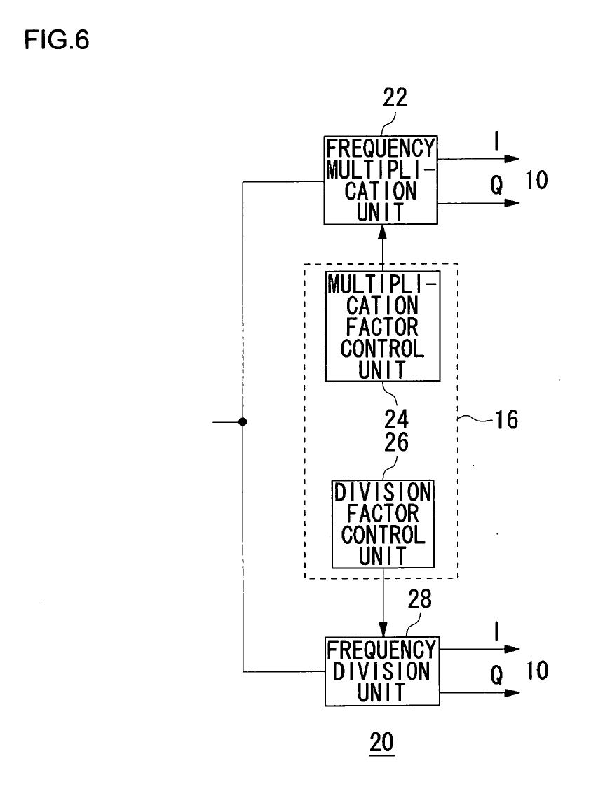

The frequency conversion apparatus 100 according to this modification includes the SSB mixer 10 of FIG. 5 and a signal input unit 20. The signal input unit 20 includes the configuration shown in FIG. 6. FIG. 6 is a diagram showing an example of a configuration of the signal input unit 20 according to the modification of the preferred embodiment of the present invention. The signal input unit 20 includes a frequency multiplication unit 22, a frequency division unit 28, and a frequency control unit 16 which is shown by the broken line in FIG. 6. In other words, the signal input unit 20 of FIG. 6 is composed of: the frequency division unit 28 corresponding to the first input unit 12 of FIG. 5; the frequency multiplication unit 22 corresponding to the second input unit 14 of FIG. 5; and the frequency control unit 16. The frequency control unit 16 may include a multiplication factor control unit 24 and a division factor control unit 26.

The frequency multiplication unit 22 multiplies the frequency of the first signal input by a predetermined multiplication factor, thereby generating a signal having a frequency an even number times the frequency. The multiplication factor control unit 24 controls the multiplication factor of the frequency multiplication unit 22.

The frequency division unit 28 divides the frequency of the second signal input by a predetermined division factor, thereby generating the first signal such that the second signal has a frequency an even number times that of the first signal generated. The division factor control unit 26 controls the division factor of the frequency division unit 28.

According to the foregoing aspect, the multiplication factor control unit can control the frequency multiplication unit so that the frequencies of the respective signals for the first and second input units to input to the mixer are set flexibly. Moreover, the division factor control unit can control the frequency division unit so that the frequencies of the respective signals for the first and second input units to input to the mixer are set flexibly.

Another modification of the preferred embodiment of the present invention will now be described. The preferred embodiment of the present invention relates to a frequency conversion apparatus. The frequency conversion apparatus according to this modification has a configuration similar to that of the frequency conversion apparatus 100 shown in FIG. 5. A difference from the preferred embodiment of the present invention consists in the configuration of the first input unit 12 of FIG. 5. It should be appreciated that elements common to the foregoing embodiment will be designated with identical reference numerals, and a description thereof will be given in a simplified form.

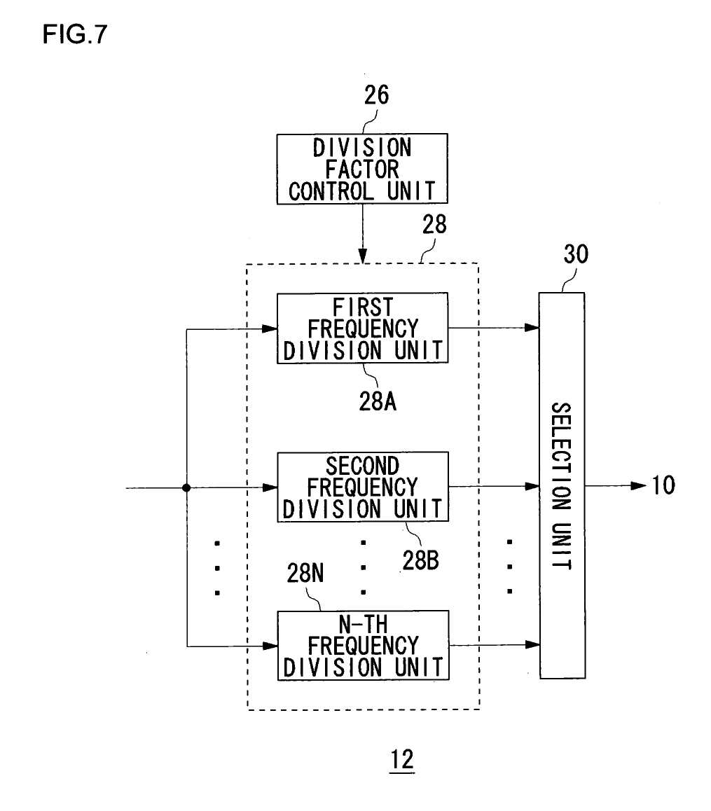

FIG. 7 is a diagram showing an example of configuration of the first input unit 12 according to this modification of the preferred embodiment of the present invention. The first input unit 12 includes a division factor control unit 26, a frequency division unit 28, which is shown by the broken line in FIG. 7, and a selection unit 30. The frequency division unit 28 includes N frequency division units such as a first frequency division unit 28A, a second frequency division unit 28B, and an Nth frequency division unit 28N.

The N frequency division units 28 divide the second signal input from the second input unit 14 by respective different division factors, thereby generating a plurality of signals having respective different frequencies.

The division factor control unit 26 controls the division factors of the respective plurality of frequency division units 28A to 28N so that the second signal has a frequency an even number times each of the plurality of signals generated by the respective plurality of frequency division units 28A to 28N. That is, the frequency division unit 28 has division factors 2m, where m represents integers not smaller than 1. For example, if the second signal has a frequency f₀, the signals generated by the frequency division unit 28 have respective different frequencies f₀/2m. The selection unit 30 selects one signal from among the signals having the frequencies f₀/2m, generated by the respective plurality of frequency division units, and inputs the selected signal to one of the input terminals of the mixer.

According to the foregoing aspect, the provision of the plurality of frequency division units can increase alternatives of the signal frequency for the first input unit to input to the mixer. It should be appreciated that the frequencies of the respective signals for the first and second input units to input to the mixer can be set flexibly.

Next, yet another modification of the preferred embodiment of the present invention will be described. Initially, an overview of the same will be given. The preferred embodiment of the present invention relates to a frequency conversion apparatus. The frequency conversion apparatus according to this modification uses mixers to mix a predetermined input signal with a signal generated by dividing the frequency of the input signal, thereby converting the frequency of the input signal for output. What can be mixed with the input signal are signals each generated by dividing the frequency of the input signal in a plurality of times. That is, one signal to be mixed is selected depending on the frequency of the signal for the mixer to output. Consequently, in terms of the frequency of the output signal, it is only the signal having the basic frequency that appears in the signal band of 12f₁/16 to 18f₁/16. Spurious signals are shifted to outside the signal band. It should be appreciated that elements common to the foregoing embodiment will be designated with identical reference numerals, and a description thereof will be given in a simplified form.

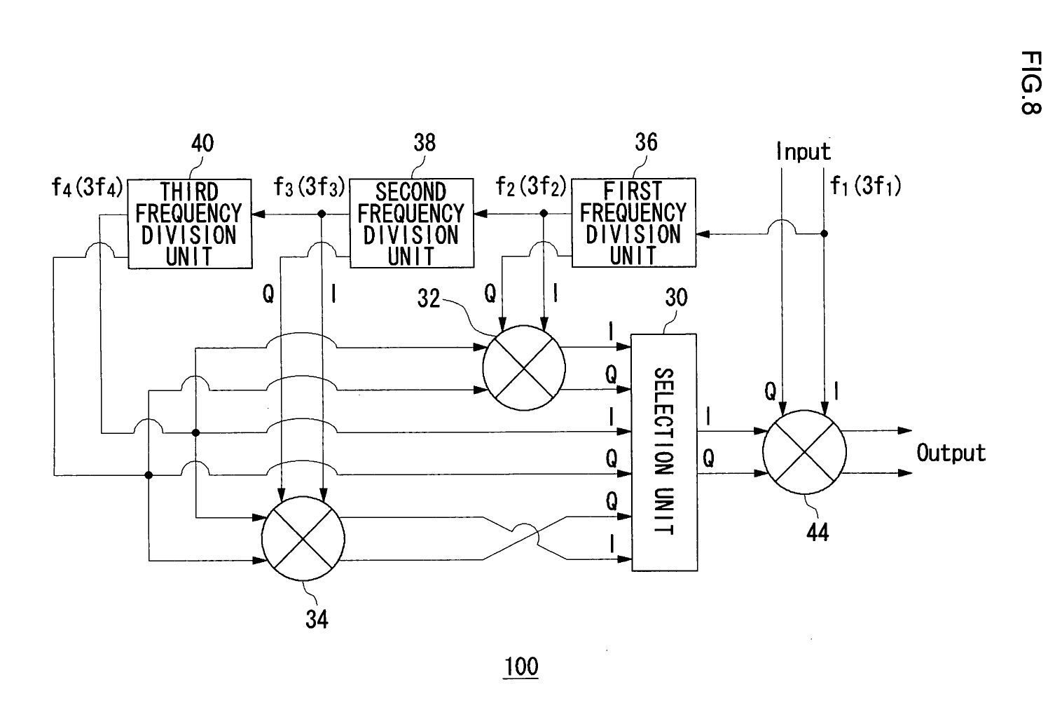

FIG. 8 is a diagram showing an example of a configuration of the frequency conversion apparatus 100 according to this modification of the embodiment of the present invention. The frequency conversion apparatus 100 includes a first frequency division unit 36, a second frequency division unit 38, a third frequency division unit 40, a first mixer 32, a second mixer 34, a selection unit 30, and a third mixer 44.

A not-shown input unit inputs a first signal having a first frequency. The first frequency division unit 36 divides the frequency f₁ of the first signal input from the input unit by four, thereby generating a signal having a frequency ¼ that of the first signal. The second frequency division unit 38 divides the frequency of the signal divided by the first frequency division unit 36 by two, thereby generating a signal having a frequency ⅛ that of the first signal. The third frequency division unit 40 divides the frequency of the signal divided by the second frequency division unit 38 by two, thereby generating a signal having a frequency 1/16 that of the first signal.

The first mixer 32 mixes the signal frequency-divided by the first frequency division unit 36, having the frequency ¼ that of the first signal, with the signal frequency-divided by the third frequency division unit 40, having the frequency 1/16 that of the first signal. Assuming that the signal input from the input unit has a frequency of f₁ (3f₁), the output signal mixed by the first mixer 32 has a frequency that is given by the following equation (3). This equation (3) shows that the spurious signal (3f₂) of f₂ is shifted to 3f₂+f₄, and the spurious signal (3f₂) of f₂ is shifted to f₂+3f₄:
f₂ (3f₂)*f₄ (3f₄)=f₂−f₄ (f₂+3f₄,3f₂+f₄), Eq. (3)
where f₂=f₁/4, and f₄=f₁/16.

The second mixer 34 mixes the signal frequency-divided by the second frequency division unit 38, having the frequency ⅛ that of the first signal, with the signal frequency-divided by the third frequency division unit 40, having the frequency 1/16 that of the first signal. The output signal mixed by the second mixer 34 has a frequency that is given by the following equation (4). This equation (4) shows that the spurious signal (3f₃) of f₃ is shifted to 3f₃+f₄, and the spurious signal (3f₄) of f₄ is shifted to f₃+3f₄:
f₃(3f₃)*f₄(3f₄)=f₃−f₄(f₃+3f₄,3f₃+f₄), Eq. (4)
where f₃=f₁/8.

The selection unit 30 selects any one signal as a second signal from among the signal mixed by the first mixer 32, the signal mixed by the second mixer 34, and the signal generated by the third frequency division unit 40. More specifically, the signal selected as the second signal has any one of the following frequencies: f₂−f₄ (f₂+3f₄, 3f₂+f₄) output from the first mixer 32; f₁/16 output from the third frequency division unit 40; and f₃−f₄(f₃+3f₄, 3f₃+f₄) output from the second mixer 34.

The third mixer 44 mixes the first signal input from the input unit with the second signal selected by the selection unit 30. What frequency the signal output from the third mixer 44 has will now be described on a case-by-case basis. Initially, if the selection unit 30 selects the signal output from the first mixer 32 as the second signal, the signal output from the third mixer 44 has a frequency given by the following equation (5):
f₁*{f₂−f₄(f₂+3f₂,3f₂+f₄)}=f₁−f₂+f₄(f₁−f₂−3f₄,f₁+3f₂
+f₄)=13f₁/16(9f₁/16,29f₁/16). Eq. (5)

If the selection unit 30 selects the signal output from the third frequency division unit 40 as the second signal, the signal output from the third mixer 44 has a frequency given by the following equation (6):
f₁*f₄(3f₄)=f₁−f₄ (f₁+3f₄)=15f₁/16(19f₁/16). Eq. (6)

If the selection unit 30 selects the signal output from the second mixer 34 as the second signal, the signal output from the third mixer 44 has a frequency given by the following equation (7):
f₁*{f₃−f₄(f₃+3f₄,3f₃+f₄)}=f₁+f₃−f₄(f₁+f₃+3f₄,f₁−3f₃
−f₄)=17f₁/16(21f₁/16,9f₁/16). Eq. (7)

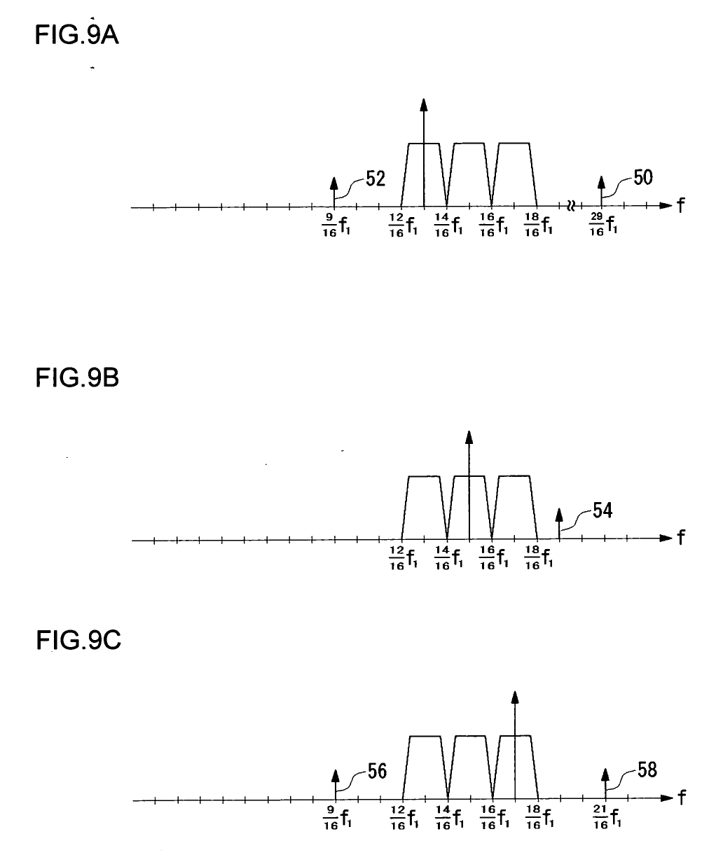

Now, the frequency distributions of the signals output from the third mixer 44, given by equations (5) to (7), respectively, will be shown on charts. FIGS. 9A to 9C are charts for showing examples of the distribution of the frequency components included in the respective output signals of the frequency conversion apparatus 100 shown in FIG. 8. The horizontal axes indicate the frequency, and the vertical axes indicate the amplitude. In each of FIGS. 9A to 9C, the range from 12f₁/16 to 18f₁/16 represents the signal band of the output signal.

FIG. 9A is a chart showing the frequency distribution corresponding to equation (5). FIG. 9A shows that a first spurious signal 50 and a second spurious signal 52 having frequencies of 9f₁/16and 29f₁/16 corresponding to the spurious components shown in the parenthesis of equation (5) are both shifted to outside the signal band. Similarly, FIGS. 9B and 9C show that a third spurious signal 54, a fourth spurious signal 56, and a fifth spurious signal 58 having frequencies corresponding to the spurious components shown in the parentheses of equations (6) and (7) are all shifted to outside the signal bands.

According to the foregoing aspect, the harmonic signal included in one of the input signals of the first mixer is mixed with the harmonic signal of the other which has a frequency component an even number times the harmonic signal. As a result, the frequency of the harmonic component signal included in the first signal can be shifted to a position away from the basic frequency, i.e., outside the signal band. Moreover, the sinusoidal signal having the basic frequency included in the one input signal of the first mixer is mixed with the other signal which has a frequency twice the basic frequency. This makes it possible to output the sinusoidal signal having the basic frequency of the input signal intactly. The same holds for the second mixer.

Up to this point, the present invention has been described in conjunction with the preferred embodiment thereof. This preferred embodiment is given solely by way of illustration. It should be understood by those skilled in the art that various modifications may be made to combinations of the foregoing components and processes, and all such modifications are also intended to fall within the scope of the present invention.

One of the modifications of the present invention has dealt with the case where the frequency conversion apparatus 100 includes the frequency multiplication unit 22, the multiplication factor control unit 24, the division factor control unit 26, and the frequency division unit 28. The present invention is not limited thereto, however. The frequency conversion apparatus 100 may include the frequency multiplication unit 22 and the multiplication factor control unit 24 alone, or the division factor control unit 26 and the frequency division unit 28 alone. In either case, it is possible to control the relationship between the frequencies of the two signals to be input to the SSB mixer 10.

What is claimed is:

1. A frequency conversion apparatus comprising:
a first input unit which inputs a first signal which includes at least a first sinusoidal signal having a first basic frequency and a first harmonic signal equivalent to a harmonic component three times the first basic frequency;
a second input unit which inputs a second signal which includes a second sinusoidal signal having a second basic frequency equivalent to a frequency an even number times the first basic frequency and a second harmonic signal equivalent to a harmonic component three times the second basic frequency;
a mixer which mixes the first signal input from the first input unit with the second signal input from the second input unit, wherein
the mixer performs a frequency shift on the first harmonic signal so as to shift to a frequency generated by addition/subtraction between the frequency of the first harmonic signal and the frequency of the second harmonic signal, and performs a frequency shift on the first harmonic signal so as to shift to a frequency generated by addition/subtraction between the frequency of the first harmonic signal and the second basic frequency.

2. The frequency conversion apparatus according to claim 1, wherein
the second input unit comprises:
a frequency multiplication unit which multiplies the frequency of the first signal input from the first input unit, thereby generating a signal having a frequency an even number times the frequency of the first signal; and
a multiplication factor control unit which controls the multiplication factor of the frequency multiplication unit.

3. The frequency conversion apparatus according to claim 1, wherein
the first input unit comprises:
a frequency division unit which divides the frequency of the second signal input from the second input, thereby generating the first signal such that the second signal has a frequency an even number times that of the first signal generated; and
a division factor control unit which controls the division factor of the frequency division unit.

4. The frequency conversion apparatus according to claim 1, wherein
the first input unit comprises:
a plurality of frequency division units which divide the frequency of the second signal input from the second input unit by respective different division factors, thereby generating a respective plurality of signals;
a division factor control unit which controls the division factors of the respective plurality of frequency division units so that the second signal has a frequency an even number times each of the plurality of signals generated by the respective plurality of frequency division units; and
a selection unit which selects any one of the signals generated by the respective plurality of frequency division units, and inputs the signal to one of the input terminals of the mixer.

5. The frequency conversion apparatus according to claim 1, wherein the mixer is a single sideband mixer.

6. A frequency conversion apparatus comprising:
a first input unit which inputs a first signal which includes at least a first sinusoidal signal having a first basic frequency and a first harmonic signal equivalent to a harmonic component three times the first basic frequency;
a second input unit which inputs a second signal which includes at least a second sinusoidal signal having a second basic frequency equivalent to a frequency twice the first basic frequency and a second harmonic signal containing a harmonic component six times the first basic frequency; and
a mixer which mixes the first signal input from the first input unit with the second signal input from the second input unit, wherein
by mixing the first signal input from the first input unit with the second signal input from the second input unit, the mixer adds the frequency of the first harmonic signal and the second basic frequency to shift the first harmonic signal to a frequency five times the first basic frequency while maintaining at least the first basic frequency of the first sinusoidal signal.

7. The frequency conversion apparatus according to claim 6, wherein
the second input unit comprises:
a frequency multiplication unit which multiplies the frequency of the first signal input from the first input unit, thereby generating a signal having a frequency an even number times the frequency of the first signal; and
a multiplication factor control unit which controls the multiplication factor of the frequency multiplication unit.

8. The frequency conversion apparatus according to claim 6, wherein
the first input unit comprises:
a frequency division unit which divides the frequency of the second signal input from the second input unit, thereby generating the first signal such that the second signal has a frequency an even number times that of the first signal generated; and
a division factor control unit which controls the division factor of the frequency division unit.

9. The frequency conversion apparatus according to claim 6, wherein
the first input unit comprises:
a plurality of frequency division units which divide the frequency of the second signal input from the second input unit by respective different division factors, thereby generating a respective plurality of signals;
a division factor control unit which controls the division factors of the respective plurality of frequency division units so that the second signal has a frequency an even number times each of the plurality of signals generated by the respective plurality of frequency division units; and
a selection unit which selects any one of the signals generated by the respective plurality of frequency division units, and inputs the signal to one of the input terminals of the mixer.

10. The frequency conversion apparatus according to claim 6, wherein the mixer is a single sideband mixer.

11. A frequency conversion apparatus comprising:
an input unit which inputs a first signal having a first frequency;
a first frequency division unit which divides the frequency of the first signal input from the input unit by four, thereby generating a signal having a frequency ¼ that of the first signal;
a second frequency division unit which divides the frequency of the signal divided by the first frequency division unit by two, thereby generating a signal having a frequency ⅛ that of the first signal;
a third frequency division unit which divides the frequency of the signal divided by the second frequency division unit by two, thereby generating a signal having a frequency 1/16 that of the first signal;
a first mixer which mixes the signal frequency-divided by the first frequency division unit, having the frequency ¼ that of the first signal, with the signal frequency-divided by the third frequency division unit, having the frequency 1/16 that of the first signal;
a second mixer which mixes the signal frequency-divided by the second frequency division unit, having the frequency ⅛ that of the first signal, with the signal frequency-divided by the third frequency division unit, having the frequency 1/16 that of the first signal;
a selection unit which selects any one signal as a second signal from among the signal mixed by the first mixer, the signal mixed by the second mixer, and the signal generated by the third frequency division unit; and
a third mixer which mixes the first signal input from the input unit with the second signal selected by the selection unit.

12. The frequency conversion apparatus according to claim 11, wherein the mixer is a single sideband mixer.

13. A frequency conversion method comprising:
inputting a first signal which includes at least a first sinusoidal signal having a first basic frequency and a first harmonic signal having a harmonic component three times the first basic frequency;
inputting a second signal which includes a second sinusoidal signal having a second basic frequency equivalent to a frequency an even number times the first basic frequency and a second harmonic signal equivalent to a harmonic component three times the second basic frequency; and
mixing the first signal with the second signal, wherein
the mixing includes: performing a frequency shift on the first harmonic signal so as to shift to a frequency generated by addition or subtraction between the frequency of the first harmonic signal and the frequency of the second harmonic signal, and outputting the resultant; and performing a frequency shift on the same so as to shift to a frequency generated by addition or subtraction between the frequency of the first harmonic signal and the second basic frequency, and outputting the resultant.
